(19) United States
(12) Patent Application Publication
(10) Pub. No.: US 2024/0332598 A1
(43) Pub. Date: Oct. 3, 2024

(54) BATTERY MODULE

(71) Applicant: HONDA MOTOR CO., LTD., Tokyo (JP)

(72) Inventors: Takeo FUJII, Saitama (JP); Ryotaro KANEKO, Saitama (JP); Yosuke YOSHIZAWA, Saitama (JP); Satoshi HIRAWAKI, Saitama (JP)

(21) Appl. No.: 18/621,127

(22) Filed: Mar. 29, 2024

(30) Foreign Application Priority Data
Mar. 29, 2023 (JP) 2023-053232

(51) Int. Cl. H01M 10/04; H01M 10/0562; H01M 50/204

(52) U.S. Cl. CPC H01M 10/0468; H01M 10/0562; H01M 50/204

(57) ABSTRACT

Provided is a battery module including: a battery cell stack including a plurality of battery cells that are stacked; a pair of plate-shaped members provided at both ends of the battery cell stack in a stacking direction of the battery cell stack; and a cushioning member disposed between the plurality of battery cells and/or between the battery cell stack and the plate-shaped member. The cushioning member includes a pair of first elastic members and a plurality of second elastic members disposed between the pair of first elastic members. The first elastic members are disposed on both outer sides of the plurality of second elastic members in the stacking direction of the battery cell stack, and each of the plurality of second elastic members includes corrugated leaf springs that are stacked in the stacking direction of the battery cell stack.

This application is based on and claims the benefit of priority from Japanese Patent Application No. 2023-053232, filed on 29 Mar. 2023, the content of which is incorporated herein by reference.

### BACKGROUND OF THE INVENTION

### Field of the Invention

The present invention relates to a battery module.

### Related Art

In recent years, research and development of secondary batteries that contribute to energy efficiency has been carried out in order to ensure many people have access to affordable, reliable, sustainable, and advanced energy.

A battery cell expands and contracts accompanying charge and discharge. For this reason, a battery module includes, for example, a pair of end plates provided at both ends of a battery cell stack in the stacking direction, and a binding bar restraining the battery cell stack between the pair of end plates.

Japanese Unexamined Patent Application, Publication No. 2022-156427 discloses a power storage device including a power storage module in which a plurality of power storage cells are stacked in a stacking direction, a housing case in which the power storage module is housed, and a restriction unit disposed between the power storage cells. The restriction unit includes a first flat plate and a second flat plate arranged apart from each other in the stacking direction, and a corrugated plate disposed between the first flat plate and the second flat plate.
Patent Document 1: Japanese Unexamined Patent Application, Publication No. 2022-156427

### SUMMARY OF THE INVENTION

In the power storage device disclosed in Japanese Unexamined Patent Application, Publication No. 2022-156427, when the restriction unit is compressed due to expansion of the power storage cells at the time of charge, a difference in surface pressure increases between portions of the first and second flat plates that are in contact with the corrugated plate and portions of the first and second flat plates that are not in contact with the corrugated plate, whereby the uniformity of the surface pressure of the restriction unit becomes low.

An object of the present invention is to provide a battery module capable of increasing the uniformity of the surface pressure of a cushioning member.

A first aspect of the present invention is directed to a battery module including: a battery cell stack including a plurality of battery cells that are stacked; a pair of plate-shaped members provided at both ends of the battery cell stack in a stacking direction of the battery cell stack; and a cushioning member disposed between the plurality of battery cells and/or between the battery cell stack and the plate-shaped member. The cushioning member includes a pair of first elastic members and a plurality of second elastic members disposed between the pair of first elastic members. The first elastic members are disposed on both outer sides of the plurality of second elastic members in the stacking direction of the battery cell stack, and each of the plurality of second elastic members includes corrugated leaf springs that are stacked in the stacking direction of the battery cell stack. Each of the corrugated leaf springs has recesses and protrusions that alternate and are continuous with each other and extend in a predetermined direction, and the recesses and the protrusions of adjacent ones of the corrugated leaf springs face and are in contact with each other.

According to a second aspect of the present invention, in the battery module as described in the first aspect, the plurality of second elastic members are arranged at predetermined intervals.

According to a third aspect of the present invention, in the battery module as described in the second aspect, adjacent ones of the plurality of second elastic members are spaced apart from each other by a distance of 0.8 mm or greater and 2.0 mm or less.

According to a fourth aspect of the present invention, in the battery module as described in the second aspect, in a state in which the battery cells are uncharged, a neutral plane of the corrugated leaf spring in a ½ cycle is substantially identical to an arc formed with a radius R and a center angle θ, and the distance between the adjacent ones of the plurality of second elastic members is equal to ΔL expressed by the following equation [1]:

$$Δ L = 2 N \times ( R θ - 1 / 2 ) \qquad [ 1 ]$$

where N is the number of waves that the corrugated leaf spring has in a state in which the battery cells are uncharged, and l is a width of each one of the waves that the corrugated leaf spring has in a state in which the battery cells are uncharged.

According to a fifth aspect of the present invention, in the battery module as described in any one of the first to fourth aspects, the battery cells are solid battery cells.

The battery module according to present invention is capable of increasing the uniformity of the surface pressure of the cushioning member.

### BRIEF DESCRIPTION OF THE DRAWINGS

FIG. 1 is a cross-sectional view illustrating an example of a battery module according to an embodiment;

FIG. 2 is an enlarged view of a portion of the battery module of FIG. 1;

FIG. 3 is an enlarged view of a corrugated leaf spring of FIG. 2; and

FIG. 4 is a diagram illustrating an arc that is substantially the same as a neutral plane of the corrugated leaf spring in a ½ cycle in an uncompressed state.

### DETAILED DESCRIPTION OF THE INVENTION

An Embodiment of the present invention will be described with reference to the drawings.

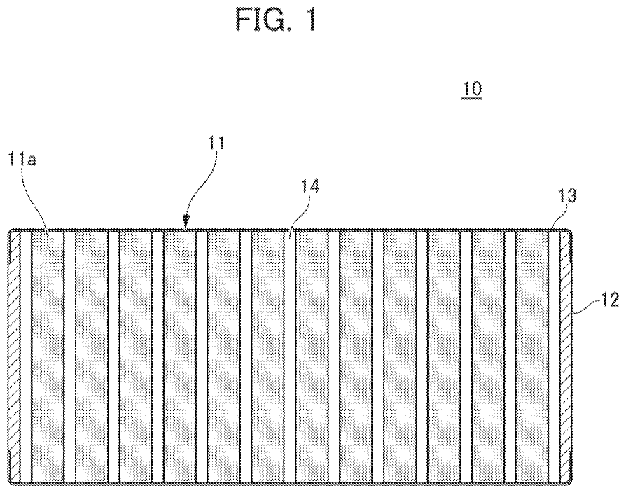

FIG. 1 illustrates an example of a battery module according to the present embodiment.

A battery module 10 includes a battery cell stack 11 in which a plurality of battery cells 11a are stacked, end plates 12 as a pair of plate-shaped members that are provided at both ends of the battery cell stack 11 in the stacking direction, and binding bars 13 as restraining members that restrain the battery cell stack 11 between the pair of end plates 12. Here, the binding bars 13 are disposed at two locations, namely, an upper portion and a lower portion in the figure.

In the battery module 10, cushioning members 14 are disposed between the plurality of battery cells 11a and between the battery cell stack 11 and the end plates 12.

The cushioning members 14 may be disposed between the plurality of battery cells 11a or between the battery cell stack 11 and the end plate 12.

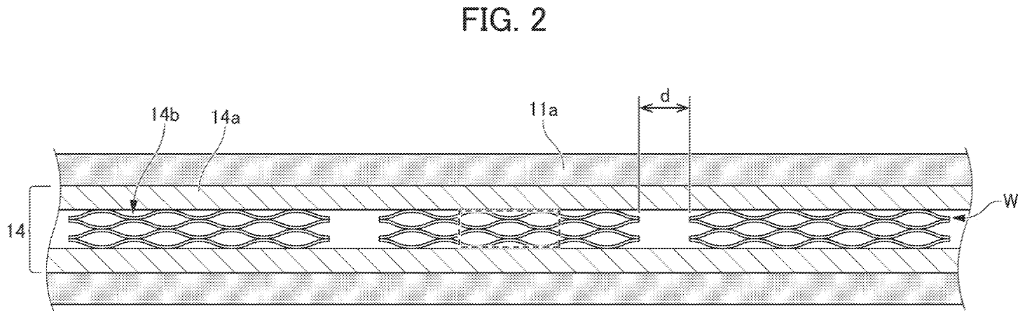

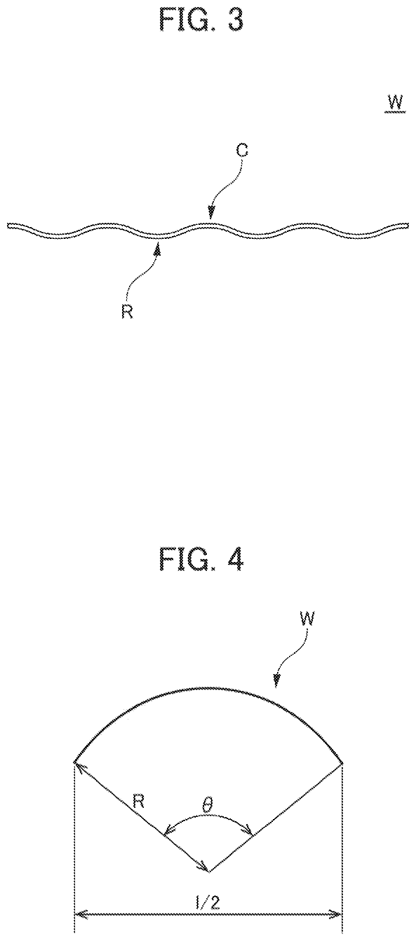

As illustrated in FIG. 2, each cushioning member 14 includes foam members 14a as a pair of first elastic members, and leaf spring stacks 14b as a plurality of second elastic members disposed between the pair of foam members 14a. The foam members 14a are disposed on both outer sides of the plurality of leaf spring stacks 14b in the stacking direction of the battery cell stack 11. Each leaf spring stack 14b includes corrugated leaf springs W that are stacked in the stacking direction of the battery cell stack 11. This configuration reduces hysteresis loss of the cushioning member 14. As illustrated in FIG. 3, each corrugated leaf spring w includes recesses R and protrusions C that alternate and are continuous with each other, and that extend in the depth direction in the figure. The recesses R and the protrusions C of adjacent ones of the corrugated leaf springs W face and are in contact with each other. The recess R and the protrusion C are respectively convex downward and upward in the stacking direction of the battery cell stack 11.

During charge of the battery cells 11a, the battery cells 11a expand, whereby each cushioning member 14 is compressed. At this time, since the foam member 14a is interposed between the battery cell 11a and the leaf spring stacks 14b, a difference in surface pressure between portions of the foam member 14a that are in contact with the leaf spring stacks 14b and portion of the foam member 14a that are not in contact with the leaf spring stacks 14b decreases to a low level, thereby increasing the uniformity of the surface pressure.

Each leaf spring stack 14b has a hollow structure, thereby reducing heat transfer between adjacent battery cells 11a. Furthermore, by using a blower such as a fan to blow air onto the leaf spring stacks 14b, the battery cells 11a can be air-cooled.

The number of the stacked corrugated leaf springs W is not particularly limited, but is, for example, 2 or more and 6 or less, and preferably 2 or more and 4 or less.

The plurality of leaf spring stacks 14b are arranged at predetermined intervals. This configuration reduces hysteresis loss of the leaf spring stacks 14b.

The adjacent leaf spring stacks 14b are spaced apart from each other by a distance d of preferably 0.8 mm or greater and 2.0 mm or less, and more preferably 0.8 mm or greater and 1.8 mm or less. In a case where the distance d between the adjacent leaf spring stacks 14b is 0.8 mm or greater, the hysteresis loss of the leaf spring stacks 14b is reduced. In a case where the distance d is 2.0 mm or less, the uniformity of the surface pressure of the cushioning member 14 increases.

In this configuration, when a neutral plane of the corrugated leaf spring W in a ½ cycle in an uncompressed state is substantially the same as an arc formed with a radius R and a center angle θ (see FIG. 4), a width ΔL by which the corrugated leaf spring W becomes wider in a state in which the corrugated leaf spring W is compressed to be made flat than in the uncompressed state is expressed by the following equation [1].

$$Δ L = 2 N \times ( R θ - 1 / 2 ) \qquad [ 1 ]$$

In the equation, N is the number of waves that the corrugated leaf spring W has in the uncompressed state, and l is the width of each one of the waves that the corrugated leaf spring W has in the uncompressed state.

Thus, in a case where the distance d between the adjacent leaf spring stacks 14b is set to be equal to ΔL in a state where the battery cells 11a are uncharged and the corrugated leaf springs W are in the uncompressed state, the adjacent leaf spring stacks 14b will not come into contact with each other when the battery cells 11a are fully charged.

Between the adjacent corrugated leaf springs W, some of the recesses R and the protrusions C facing and in contact with each other are preferably bonded to each other. This configuration improves the strength of the leaf spring stack 14b.

Some of the recesses R and the protrusions C facing and in contact with each other are bonded to each other by any method. An example method includes positioning the corrugated leaf springs W using a jig, followed by bonding them with an adhesive.

The adhesive is not particularly limited as long as it can bond the corrugated leaf springs W, but an elastic adhesive is preferred in consideration of the hysteresis loss of the leaf spring stack 14b.

A configuration may be adopted in which, when each of the leaf spring stack 14b is cross-sectionally viewed in the direction in which the recesses R and the protrusions C extend, the recesses R and the protrusions C facing and in contact with each other are bonded to each other only in a center portion (which is marked with the dotted lines in FIG. 2). This configuration reduces the hysteresis loss of the leaf spring stack 14b.

In the illustrated example, among the recesses R and the protrusions C facing and in contact with each other, the recesses R and the protrusions C closest to the center and the adjacent recesses R and the adjacent protrusions C on both sides of the center are bonded. However, only the recesses R and the protrusions C closest to the center may be bonded.

The leaf spring stack 14b may be partially bonded to the foam members 14a. This configuration increases the strength of the cushioning member 14.

The leaf spring stack 14b is partially bonded to the foam members 14a by any method. An example method includes positioning the leaf spring stack 14b using a jig, followed by bonding the leaf spring stacks 14b with an adhesive.

The adhesive is not particularly limited as long as it can bond the leaf spring stack 14b to the foam members 14a, but an elastic adhesive is preferred in consideration of the hysteresis loss of the cushioning member 14.

A configuration may be adopted in which, when the cushioning member 14 is cross-sectionally viewed in the direction in which the recesses R and the protrusions C extend, the leaf spring stack 14b is bonded to the foam members 14a only in the center portion (which is marked with the dotted lines in FIG. 2). This configuration reduces the hysteresis loss of the cushioning member 14.

In this configuration, among the recesses R and the protrusions C of the leaf spring stack 14b, two recesses R and two protrusions C closest to the center are bonded to the foam members 14a.

The Young's modulus of the foam member 14a is preferably 150 MPa or greater. In the case where the Young's modulus of the foam member 14a is 150 MPa or greater, the uniformity of the surface pressure increases. The Young's modulus of the foam member 14a is not particularly limited, but is, for example, 4.5 MPa or greater and 410 MPa or less.

The Poisson's ratio of the foam member 14a is preferably 0.3 or less. In the case where the Poisson's ratio of the foam member 14a is 0.3 or less, the foam member 14a tends to absorb a change in thickness caused by expansion and contraction of the battery cells 11a. The Poisson's ratio of the foam member 14a is not particularly limited, but is, for example, 0 or greater.

The porosity of the foam member 14a is not particularly limited, but is, for example, 30% or greater and 95% or less.

The thickness of the foam member 14a in a state where the SOC is 100% is not particularly limited, but is, for example, 0.05 mm or greater and 0.1 mm or less.

Examples of the material for forming the foam member 14a include, but are not limited to, polyurethane, silicone resin, ethylene propylene rubber, styrene resin, olefin resin, polyamide, and polyester.

The Young's modulus of the corrugated leaf spring W is preferably 35 GPa or greater. In the case where the Young's modulus of the corrugated leaf spring W is 35 GPa or greater, the leaf spring stack 14b tends to absorb a change in thickness caused by expansion and contraction of the battery cells 11a. The Young's modulus of the corrugated leaf spring W is not particularly limited, but is, for example, 200 GPa or less.

Examples of the material for forming the corrugated leaf spring W include, but are not limited to, metals such as stainless steel and carbon steel, resins such as epoxy resin, phenol resin, and nylon resin, and fiber reinforced plastics (FRP) such as carbon fiber reinforced plastic (CFRP) and glass fiber reinforced plastic (GFRP). Among them, FRP is preferred in consideration of the energy density of the battery module 10.

The thickness of the leaf spring stack 14b in a state where the SOC is 100% is not particularly limited, but is, for example, 1.0 mm or greater and 1.2 mm or less.

Examples of the battery cell 11a include, but are not limited to, a solid battery cell such as an all-solid lithium ion battery cell and an all-solid lithium metal battery cell, and a lithium metal battery cell. Among them, a solid battery cell is preferred.

In the following, a case where the battery cell 11a is an all-solid lithium metal battery cell will be described.

The all-solid lithium metal battery cell includes, for example, a positive electrode current collector, a positive electrode mixture layer, a solid electrolyte layer, a lithium metal layer, and a negative electrode current collector that are sequentially stacked.

The positive electrode current collector is not particularly limited, and a non-limiting example thereof is aluminum foil.

The positive electrode mixture layer contains a positive electrode active material, and may further contain a solid electrolyte, a conductive agent, a binder, and the like.

The positive electrode active material is not particularly limited as long as it is capable of occluding and releasing lithium ions, and examples thereof include, but are not limited to, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂₀₄, LiNiO₂, LiFePO₄, lithium sulfide, and sulfur.

The solid electrolyte for forming the solid electrolyte layer is not particularly limited as long as it is capable of conducting lithium ions, and examples thereof include, but are not limited to, an oxide electrolyte and a sulfide electrolyte.

The negative electrode current collector is not particularly limited, and a non-limiting example thereof is copper foil.

It should be noted that the present invention is not limited to the embodiment described above, and appropriate modifications may be made to the embodiment described above without deviating from the spirit of the present invention.

### EXPLANATION OF REFERENCE NUMERALS

10: Battery module
11: Battery cell stack
11a: Battery cell
12: End plate
13: Binding bar
14: Cushioning member
14a: Foam member
14b: Leaf spring stack
W: Corrugated leaf spring
R: Recess
C: Protrusion

What is claimed is:

1. A battery module comprising:
a battery cell stack including a plurality of battery cells that are stacked;
a pair of plate-shaped members provided at both ends of the battery cell stack in a stacking direction of the battery cell stack; and
a cushioning member disposed between the plurality of battery cells and/or between the battery cell stack and the plate-shaped member,
the cushioning member comprising a pair of first elastic members and a plurality of second elastic members disposed between the pair of first elastic members,
the first elastic members being disposed on both outer sides of the plurality of second elastic members in the stacking direction of the battery cell stack,
each of the plurality of second elastic members comprising corrugated leaf springs that are stacked in the stacking direction of the battery cell stack, wherein
each of the corrugated leaf springs has recesses and protrusions that alternate and are continuous with each other and extend in a predetermined direction, and
the recesses and the protrusions of adjacent ones of the corrugated leaf springs face and are in contact with each other.

2. The battery module according to claim 1, wherein
the plurality of second elastic members are arranged at predetermined intervals.

3. The battery module according to claim 2, wherein
adjacent ones of the plurality of second elastic members are spaced apart from each other by a distance of 0.8 mm or greater and 2.0 mm or less.

4. The battery module according to claim 2, wherein
in a state in which the battery cells are uncharged, a neutral plane of the corrugated leaf spring in a ½ cycle is substantially identical to an arc formed with a radius R and a center angle θ, and the distance between the adjacent ones of the plurality of second elastic members is equal to ΔL expressed by the following equation [1]:
$$Δ L = 2 N \times ( R θ - 1 / 2 ) \qquad [ 1 ]$$
where N is the number of waves that the corrugated leaf spring has in the state in which the battery cells are uncharged, and l is a width of each one of the waves that the corrugated leaf spring has in the state in which the battery cells are uncharged.

5. The battery module according to claim 1, wherein
the battery cells are solid battery cells.
